(19) United States
(12) Patent Application Publication
(10) Pub. No.: US 2022/0402415 A1
(43) Pub. Date: Dec. 22, 2022

(54) VEHICLE ZONAL MICROCLIMATE SYSTEM

(71) Applicant: Gentherm Incorporated, Northville, MI (US)

(72) Inventors: Scott Richard Wolas, Pasadena, CA (US); Lorenzo Marvin Crosatti, Upland, CA (US)

(21) Appl. No.: 17/892,526

(22) Filed: Aug. 22, 2022

Related U.S. Application Data
(63) Continuation of application No. 16/330,476, filed on Mar. 5, 2019.
(60) Provisional application No. 62/385,781, filed on Sep. 9, 2016.

(51) Int. Cl. B60N 2/56; B60H 1/00; B60H 1/34

(52) U.S. Cl. CPC B60N 2/5628; B60H 1/00207; B60H 1/00478; B60H 1/34; B60N 2/5657; B60H 2001/00228

(57) ABSTRACT

A vehicle occupant air curtain system includes a seat that has a seat cushion and a seat back. The seat back has a region that is configured to be arranged above an occupant shoulder. An air vent is supported on the seat back and is arranged in the region. The air vent is configured to be directed adjacent to a seated occupant's head and neck.

### CROSS-REFERENCE TO RELATED APPLICATIONS

This application is a Continuation of U.S. patent application Ser. No. 16/330,476 filed on Mar. 5, 2019, which is a National Phase Application of International Application No. PCT/US2017/050677 filed on Sep. 8, 2017, which claims priority to U.S. Provisional Application No. 62/385,781, which was filed on Sep. 9, 2016 and is incorporated herein by reference.

### BACKGROUND

This disclosure relates to temperature control of a vehicle interior environment, such as within an automobile. More specifically, the disclosure relates to a vehicle microclimate system and a method for controlling the same for increasing an occupant's personal comfort.

Heating, ventilation and cooling (HVAC) systems are widely used in the automobile industry to control the temperature within the vehicle to increase occupant comfort. Increasingly, vehicles have incorporated additional, auxiliary thermal conditioning devices, such as heated and cooled seats and heated steering wheels to provide a personalized microclimate for the occupant. These auxiliary thermal conditioning devices are intended to further enhance occupant comfort.

If the vehicle interior is very hot or very cold, it may take undesirably long for the HVAC system to reach a thermally comfortable equilibrium. Additionally, although microclimate devices may be used to provide occupant comfort, these microclimate devices may not be able to overcome the effects of an uncomfortable vehicle interior. It is desirable to further improve the microclimate occupied by each occupant.

### SUMMARY

In one exemplary embodiment, a vehicle occupant air curtain system includes a seat that has a seat cushion and a seat back. The seat back has a region that is configured to be arranged above an occupant shoulder. An air vent is supported on the seat back and is arranged in the region. The air vent is configured to direct an airflow adjacent to a seated occupant's head and neck.

In a further embodiment of any of the above, the seat back includes a head rest. The head rest is adjustable with respect to a seat back support.

In a further embodiment of any of the above, the air vent is configured to be directed away from the seated occupant's head and neck.

In a further embodiment of any of the above, the air vent includes a housing and a vent. The vent is movable relative to the housing to position an airflow from the vent adjacent to and away from the seated occupant's head and neck.

In a further embodiment of any of the above, a dead zone in air directed by the air vent is aligned with the seated occupant's ears.

In a further embodiment of any of the above, the air vent is configured to provide an airflow that has at least two of 3.5 cfm+1-10%, a Reynolds number of 4500+/−10%, and a velocity of 8 m/s+/−10%.

In a further embodiment of any of the above, the air vent is a first air vent. The seat cushion includes lateral sides that each include a second air vent that is configured to direct another airflow adjacent to a seated occupant's legs.

In a further embodiment of any of the above, the second air vent is configured to provide an airflow having at least two of 3.5 cfm+/−10%, a Reynolds number of 4000+/−10%, and a velocity of 7 m/s+/−10%.

In a further embodiment of any of the above, the seat is in communication with a thermoelectric module that is configured to provide conditioned air to at least one of the first and second air vents and comprises an air inlet to the thermoelectric module that draws air from a source substantially other than the first and second air vents.

In another exemplary embodiment, a vehicle occupant air curtain system includes a seat having a seat cushion and a seat back. The seat cushion includes lateral sides that each include an air vent configured to direct an airflow adjacent to a seated occupant's legs and meet above the occupant's legs so as to continue away from the occupant.

In another exemplary embodiment, a method of generating an air curtain from a seat and about a vehicle occupant. The method includes the step of conditioning air from an inlet from a diffused, ambient environment. The conditioned air is provided to first and second air vents. A first boundary layer of air is created from a first air vent and is adjacent to an occupant's head. A second boundary layer of air is created from a second air vent and is adjacent to an occupant's legs.

In a further embodiment of any of the above, the first boundary layer creating step includes supplying the first boundary layer of air from the first air vent located on a seat back and has a region above an occupant shoulder. The second boundary layer creating step includes supplying the second boundary layer of air from the second air vent located on a lateral side of a seat cushion.

In a further embodiment of any of the above, the first and second boundary layers of air each provide an airflow having at least two of 3.5 cfm+/−10%, a Reynolds number of 4250+/−20%, and a velocity of 7.5 m/s+/−20%.

In a further embodiment of any of the above, the first and second boundary layers of air enter the vehicle cabin from the first and second vents without further obstruction.

In a further embodiment of any of the above, the first air vent includes a housing and a vent. The vent is movable relative to the housing to position an airflow from the vent adjacent to and away from the seated occupant's head and neck. The first air vent provides a dead zone arranged between an upper flow path and a lower flow path. The dead zone obstructs flow through the air vent.

In a further embodiment of any of the above, the air conditioning step is performed by passing air across a thermoelectric device operable based upon the Peltier effect.

In a further embodiment of any of the above, the air conditioning step is performed by passing air across a heat exchanger that has an evaporative liquid refrigerant.

In another exemplary embodiment, an air curtain vent for a seat includes a housing. A vent is movable relative to the housing. The vent includes a height substantially greater than a width. The height and width provide an exit that provides upper and lower flow paths. A dead zone is arranged between the upper and lower flow paths. The dead zone is configured to significantly obstruct flow through the vent.

In a further embodiment of any of the above, the vent includes a baffle that blocks at least 15% of the exit. The height is at least three times the width.

In another exemplary embodiment, a front seat includes a seat cushion and a seat back which together provide an occupant support surface. The occupant support surface is configured to provide thermal conditioning to a front seat occupant. The seat back has a thermal conditioning module opposite the occupant support surface and is configured to provide thermal conditioning to a rear occupant aft of the front seat.

In a further embodiment of any of the above, the seat back supports a radiant heating device that faces opposite the occupant support surface.

In a further embodiment of any of the above, the seat back includes an air vent that faces opposite the occupant support surface.

### BRIEF DESCRIPTION OF THE DRAWINGS

The disclosure can be further understood by reference to the following detailed description when considered in connection with the accompanying drawings wherein:

FIG. 1 is a climate control system schematic.

FIG. 1A is a schematic illustration of a first thermoelectric module.

FIG. 1B is a schematic illustration of a second thermoelectric module.

FIG. 2 is a schematic view of an example seat embodiment with an occupant air curtain system.

FIG. 3A depicts a conduit with an air vent for a seat cushion.

FIG. 3B illustrates a perspective view of the air vent shown in FIG. 3A.

FIG. 4 is an enlarged schematic view of a conduit provided in the occupant air curtain system.

FIG. 5 is a schematic view of the occupant air curtain air delivery system.

FIGS. 6A-6C are example embodiments of the occupant air curtain system incorporated into a seat bottom of the seat.

FIG. 7 shows an air vent provided in a seat back for supplying an occupant air curtain in a head and neck region of an occupant.

FIG. 8 is a cross-sectional view through the vent shown in FIG. 7 taken along line 8-8.

FIG. 8A is a perspective view of a housing of the air vent shown in FIG. 8.

FIG. 8B is a perspective view of a vent of the air vent shown in FIG. 8.

FIG. 9 illustrates an occupant air curtain in the area of the occupant head and neck.

FIG. 10 schematically illustrates the occupant air curtain deployed about an occupant.

FIGS. 11A and 11B illustrate the thermal microclimate environment about the occupant from the occupant air curtain system.

FIG. 12 schematically illustrates a rear-mounted seat occupant microclimate device.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

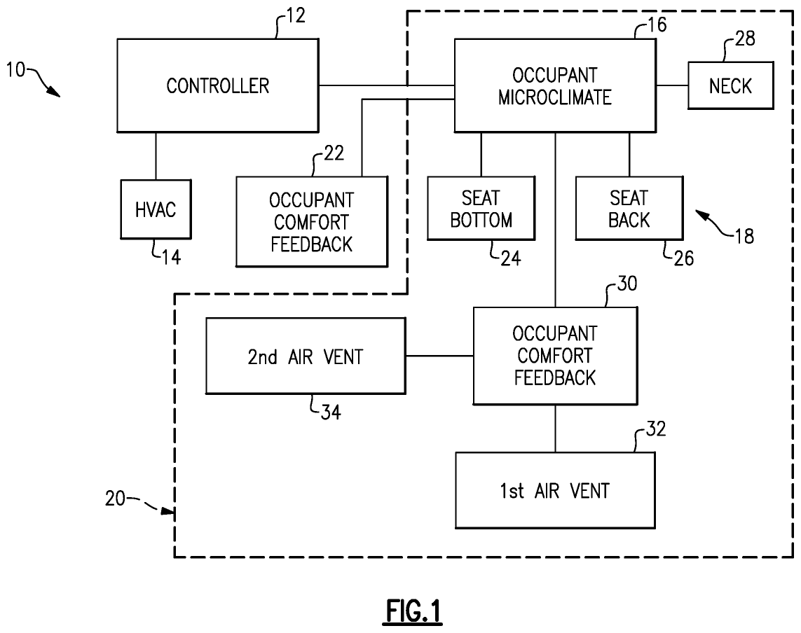

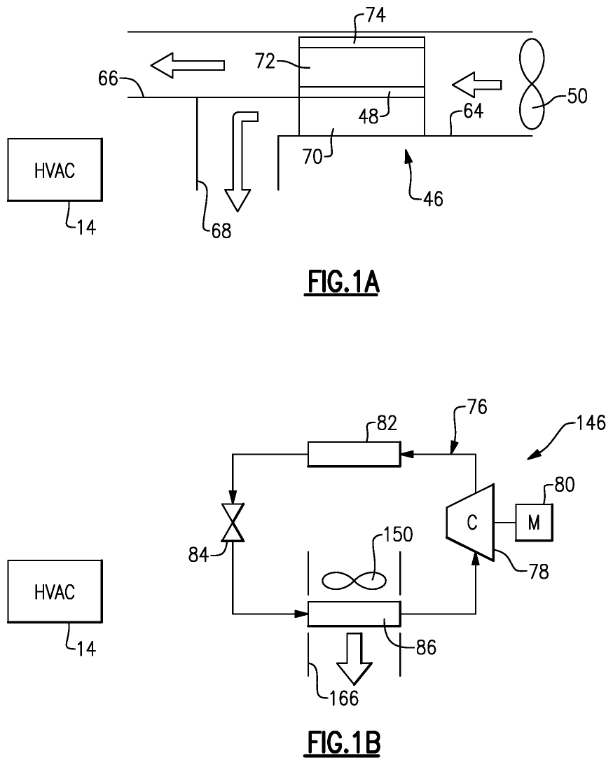

An example microclimate control system 10 is schematically shown in FIG. 1, it should be understood that the system may be different than that shown. One example climate control system is illustrated in PCT/US15/58328 entitled “VEHICLE MICROCLIMATE SYSTEM WITH TARGETED VASODILATION OF EXTREMITIES FOR IMPROVED OVERALL THERMAL COMFORT AND METHOD OF CONTROLLING SAME”, filed on Oct. 30, 2015 and incorporated herein by reference in its entirety.

The system 10 includes a controller 12 that coordinates operation of an HVAC system 14 and one or more occupant microclimate devices to provide a comfortable environment for the occupants within a vehicle. One or more foot well heating vents may be used.

Referring to FIGS. 1 and 2, one example microclimate device 18 is a seat 20. The seat 20 may include devices 24, 26 within the seat bottom or cushion 21 and seat back 22 to heat and/or cool the occupant support surfaces. A head rest 23 may be integrated with the seat back 22 or separately adjustable. One or more thermoelectric modules are used to provide the thermal conditioning to the occupant via the seat 20. For example, a thermoelectric device 46 (see, e.g., FIG. 1A) or a multi-node cooling system enabled by a micro-compressor chiller unit (see, e.g., FIG. 1B) may be used. These thermoelectric modules are separate from the vehicle's HVAC system 14.

Referring to FIG. 1A, the thermoelectric module 46 is capable of providing both heating and cooling. In one example, the thermoelectric module 46 includes a thermoelectric device 48 having a main heat exchanger 70 and a waste heat exchanger 72. The thermoelectric device is arranged in a housing providing an inlet 64 and first and second outlets 66, 68 respectively in fluid communication with the main and waste heat exchangers 70, 72. A blower 50 moves air across the thermoelectric device 148. The thermoelectric device 48 is configured to provide heating and cooling respectively in a heating mode and a cooling mode based upon a direction of current flow through the thermoelectric device 48 using the Peltier effect. A heating element 74 may be mounted to the main heat exchanger 50 to provide additional heating.

Referring to FIG. 1B, a mini-compressor chiller unit 146 is schematically shown and includes a compressor 78 driven by an electric motor 80 to circulate a refrigerant through a refrigerant loop 76. The refrigerant passes through a condenser 82, an expansion valve 84 and an evaporator 86 before returning to the compressor 78. The blower passes air across the evaporator 86 to provide conditioned air through an outlet 166. The mini-compressor chiller unit components are small in size and may be dispersed and conveniently packaged throughout the vehicle.

Returning to FIGS. 1 and 2, a neck conditioning device 28 may be provided in the headrest 23 or seat back 22. The seat 20 may include, for example, three settings for heat, which may be supplied by conductive and/or radiative device(s). A headrest convective warmer may also be used. Cooling also may be provided to the neck conditioning device 28.

The vehicle may also employ other microclimate devices, such as a heated/cooled steering wheel, heated/cooled interior panels, heated/cooled arm rests, a heated/cooled center console cover or other heated/cooled surfaces.

Thermal energy source microclimate devices can include central HVAC, auxiliary heaters (PTC heater), auxiliary thermoelectric devices, auxiliary HVAC devices such as mini-compressor systems (e.g., FIG. 1B), etc. Each microclimate device can have an associated source, or can share a source with another. In latter case, valves can be used to vary energy supplied to each device. Oscillating air flow can be created by stationary vent or vent with movable vanes.

An occupant comfort feedback device 22, such as an infrared sensor for measuring an occupant's thermal state or skin temperature, may be used to provide feedback to the system and automatically regulate the occupant's microclimate to maximize occupant comfort.

In order to improve occupant thermal comfort, it may be desirable to thermally isolate the occupant from the environment within the vehicle until the vehicle interior reaches a comfortable thermal equilibrium. Alternatively or additionally, it may be desirable to create a thermal microclimate around all or part of the occupant to reduce reliance on and energy consumed by the central HVAC for occupant conditioning. To this end, the seat provides an occupant air curtain system 30 which creates a boundary layer of conditioned air about the occupant. This boundary layer of air is different from air supplied, for example, from the typical HVAC dashboard vents or elsewhere as such air is significantly or entirely diffused and highly turbulent by the time the conditioned air reaches the occupant. As such, this air is incapable of creating a discrete boundary layer of air about the occupant. The air curtain C is a layer of air created in the immediate vicinity of the occupant that separates the occupant from air in the remainder of the interior compartment, or boundary layer. The air curtain C disrupts the flow of air from the central HVAC that is directed towards the occupant. The air curtain C may mix with air from the central HVAC and thereby alter the temperature and velocity of air from the central HVAC. As a boundary layer, the air curtain C may serve as the primary means by which the occupant is conditioned or as the primary effector of the occupant's thermal sensation.

In one embodiment, the occupant air curtain system 30 includes first and second air vents 32, 34 respectively provided in the seat back and seat bottom. In one example, air exiting the vents 32, 34 each include flow directing structure that produce first and second boundary layers of air respectively that have an airflow having at least two of 3.5 cfm+1-10%, a Reynolds number of 4250+/−20%, and a velocity of 7.5 m/s+/−20%. The air flow characteristics may depend on the area of the curtain C, and can vary based on air flow rates from the central HVAC directed towards the occupant (e.g. higher air curtain flow rates desired to maintain buffer against higher central HVAC rates, etc.) As such the air flow characteristics may be in a range of 2.5-7.0 cfm, a Reynolds number of 3000-8500, and a velocity of 5.0-15.0 m/s. In another example, all three airflow characteristics are achieved. The air flow characteristics relate to average air curtain C values, or values associated with a portion of the air curtain C. Air from an inlet to the thermoelectric module is conditioned. The inlet air comes from a source of diffused, ambient air and substantially other than the first and second air vents 32, 34. That is, the air is drawn in from away from the air curtain C generated by the first and second air vents 32, 34 so that the generated air curtain C is not “wrapped” about the occupant. The conditioned air is then provided to the first and second air vents 32, 34 and into the vehicle cabin without further obstruction.

Although not shown, the occupant air curtain system 30 can optionally have a third air vent located along a lower section of the perimeter of the seat back. In one example, the third air vent can be directed forward toward seat occupant. In an alternate example, the third air vent can be directed rearward toward an occupant of another seat.

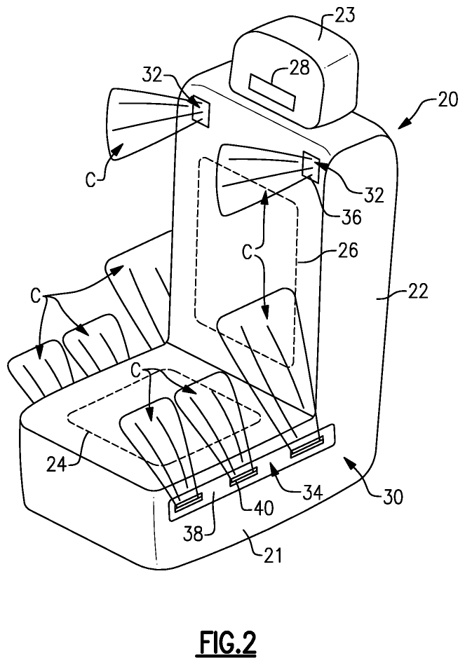

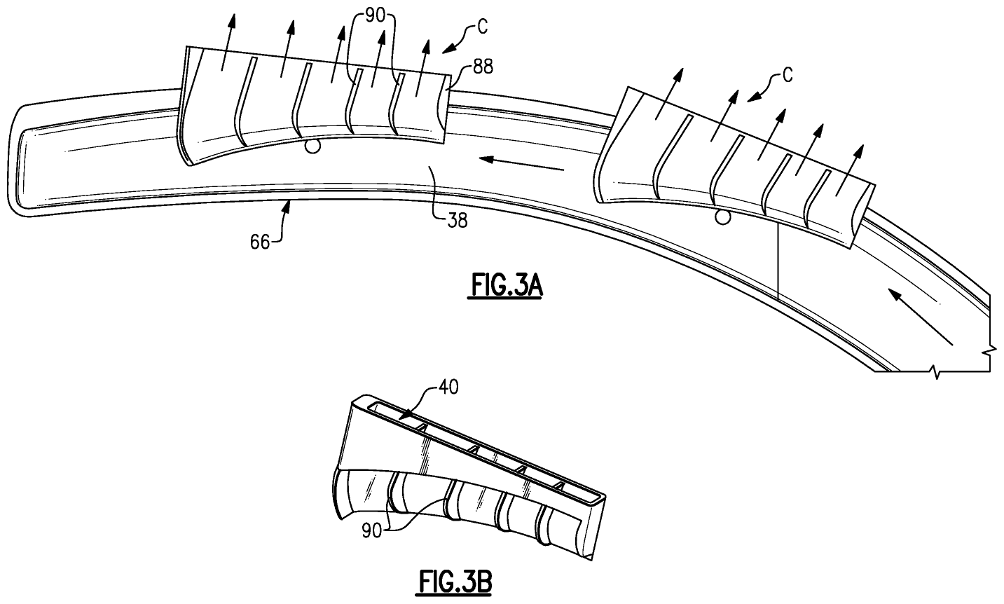

The first air vent(s) 32 may be provided by vents in the upper portion of the seat back and/or headrest (FIGS. 7-9), and the second air vent(s) 34 may be provided on lateral sides of the seat bottom 21 (FIGS. 3A-6C). These first air vents 32, which may be adjustable, are positioned to deliver a curtain C of air above the occupant's shoulders and laterally outward of and adjacent to the head and neck. That is, although a small portion of the air curtain C from the vents may impinge upon the occupant, it is intended to cool or heat the space surrounding the occupant, grazing the head and neck (or other sensitive areas), and creating a boundary layer of air in the space immediately adjacent the occupant. The first air vent 32 is configured 1) to create an envelope around the occupant's face and adjoining sides of the neck, specifically to direct air, conditioned or unconditioned, towards sides of occupant's neck and face; and 2) to avoid targeting the back of the neck.

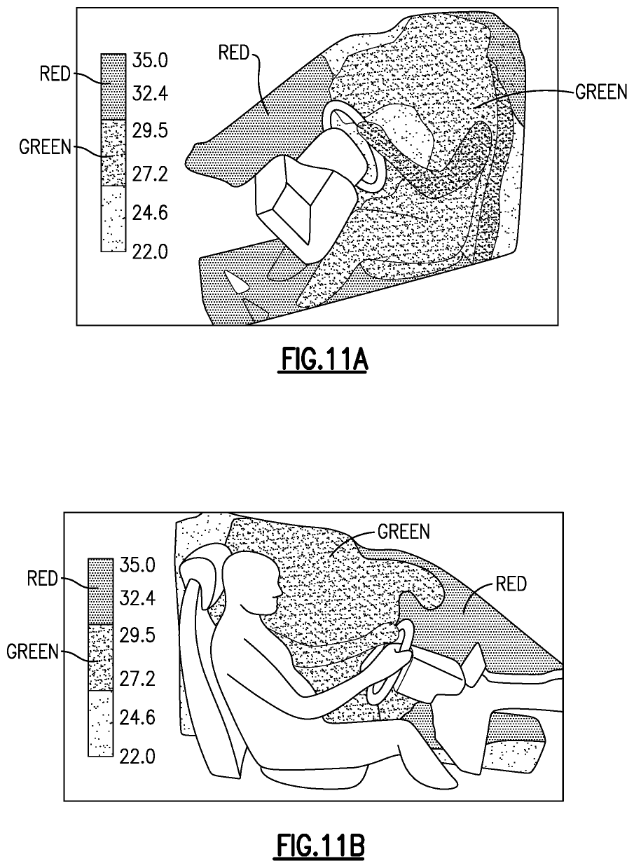

In a similar manner, each of the second air vents 34 provided at a perimeter of the seat bottom supplies a boundary layer of air about the occupant's legs and lower torso. Referring to FIGS. 3A-6C, a conduit 38 may be provided on either side of the seat bottom, or arranged in a U-shape, and includes multiple elongated slots 40, which may be provided by adjustable vents 88 having louvers 90 that redirect air from the conduit 38. Referring to FIG. 4, the slots 40, whether provided by separate vents or the wall of the conduit 38 itself, have a length 42 that is substantially greater than a width 44, for example at least 4:1. The conduit 38 may be obstructed at one or more locations to ensure desired distribution of air from one or more slots 40. An oscillating airflow may be generated, for example, by movable vanes. The elongated shape of the slots 40 provides fans of air that create a boundary layer, which sufficiently penetrates the space immediately surrounding the occupant before diffusing. For example, the second air vent 34 provides an airflow having at least two of 3.5 cfm+1-10%, a Reynolds number of 4000+/−10%, and a velocity of 7 m/s+/−10%. Again, other air flow characteristics may be provided by the second air vent 34. In this manner, a boundary layer of air is configured to create an envelope around a lower portion of the occupant, specifically 1) at sides of the seat to direct conditioned air along upper portion of legs (i.e. lap area) and along sides of torso towards (and reaching) chest; and 2) at the front of the seat towards the back of the knee and surrounding leg area. In this manner, airflow is directed adjacent to a seated occupant's legs away from the second air vents 34 in a direction 121 and meets at a point 119 above the occupant's legs so as to continue away from the occupant, as shown in FIG. 10. The airflow may subsequently stagnate due to interaction with airflow from the HVAC system.

Referring to FIG. 5, the first and second air delivery members 32, 34 may be supplied by a thermal electric module 46, for example. The thermoelectric module 46 includes a thermoelectric device 48 that may heat or cool air from a blower 50. The conditioned air is distributed with a dual duct 52 to the vents 36 and conduits 38. Of course, it should be understood that the occupant air curtain system 30 can be configured differently than shown, for example, using the mini-compressor chiller unit 146 shown in FIG. 1B.

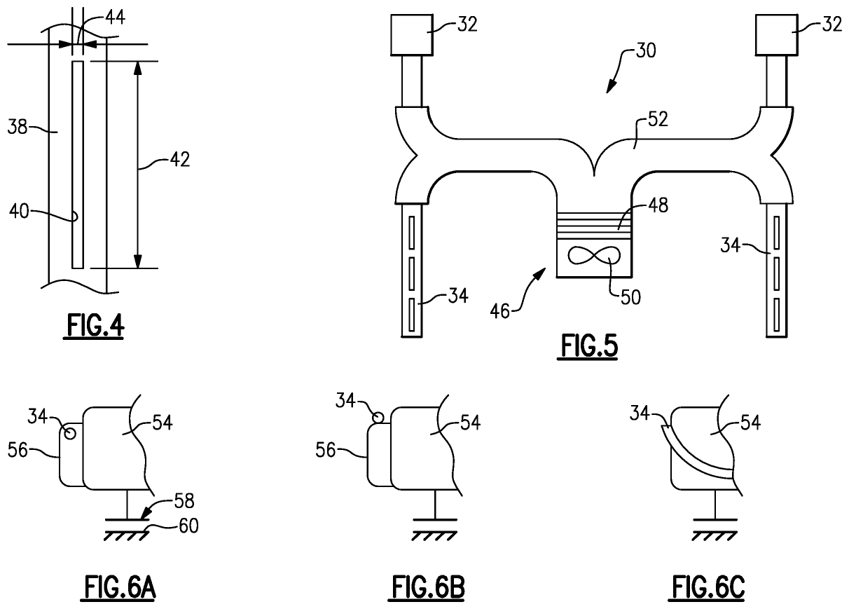

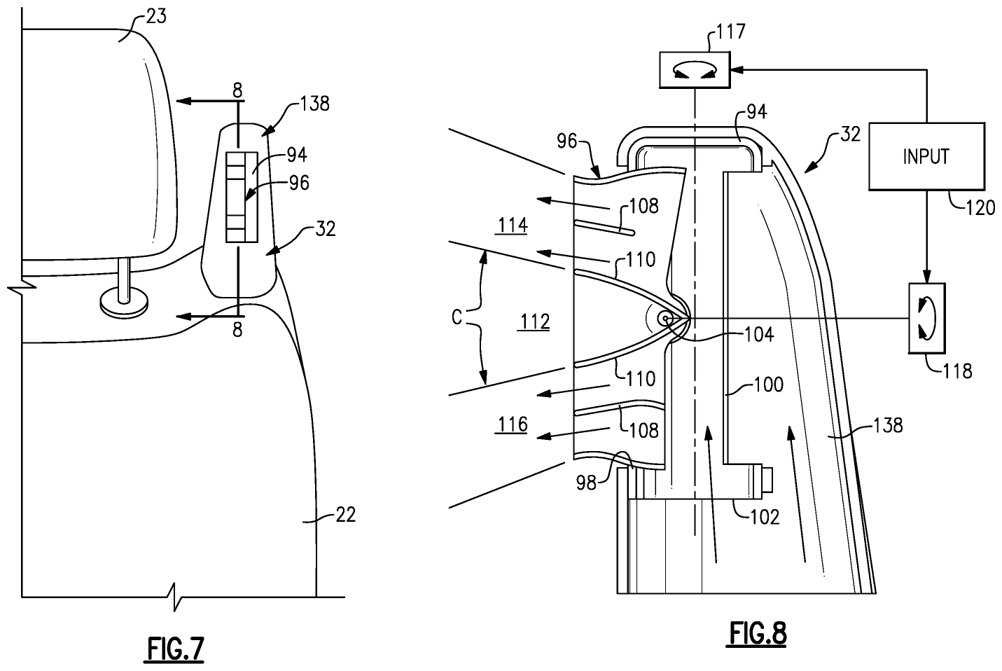

The example second air vent 34 configurations are shown in FIGS. 6A-6C. Typically, a seat bottom cushion 54 includes trim members 56 secured on lateral sides. FIG. 6A illustrates the second air vent 34 arranged interiorly of the trim 56, and FIG. 6B shows the second air vent 34, for example, conduit 38, provided exteriorly of the trim 56. As shown in FIG. 6C, illustrates the second air vent 34 extends from the cushion 54 through which conditioned air may be supplied. The seat bottom is movably supported by adjustable tracks 58 secured to the vehicle floor 60 for example. The second air vent 34 moves with the seat 20 relative to the vehicle floor 60.

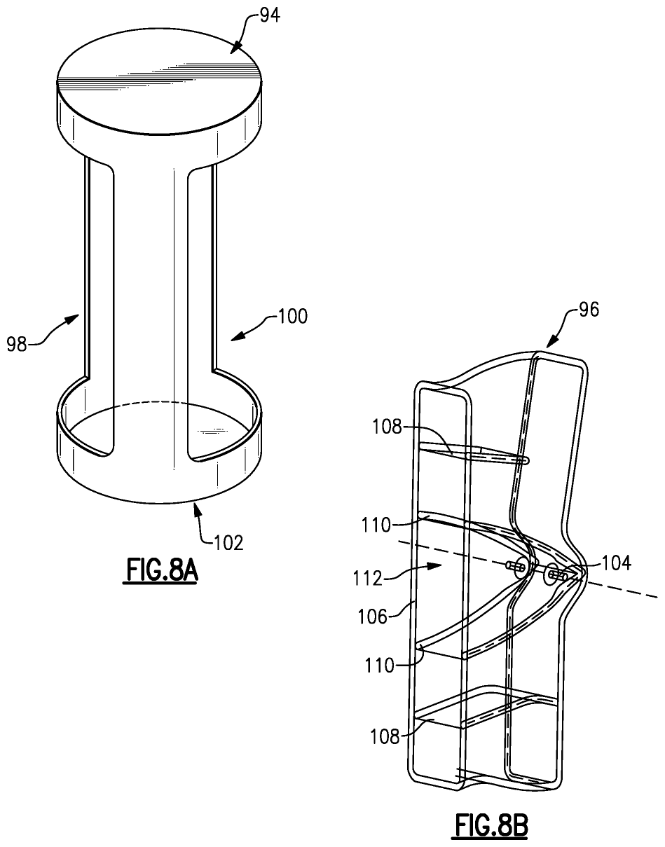

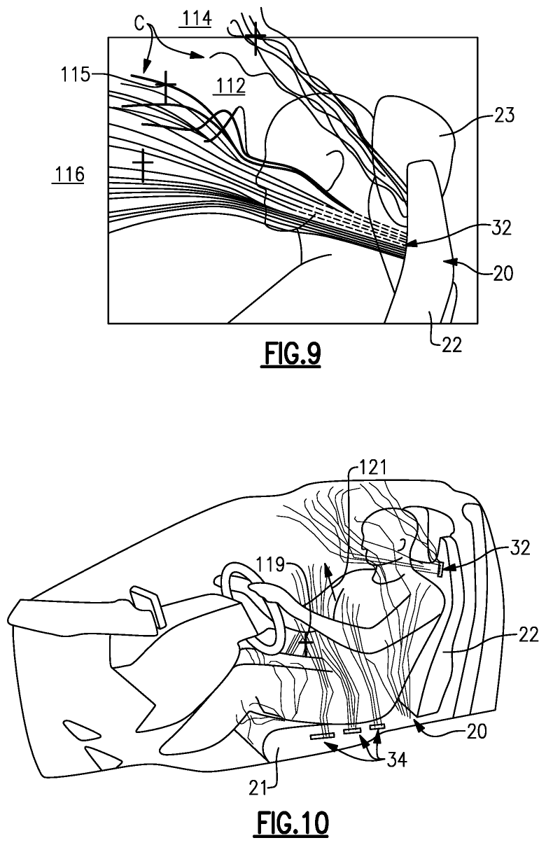

One example first air vent 32 is shown in FIG. 7 mounted on the seat back 22 and arranged in a region that is above an occupant shoulder when seated. The first air vent 32 includes a plenum 138 that supports a housing 94 rotatable about an axis in the example, as shown in FIG. 8. In the example, the plenum 138 provides an outer structure defining a fluid cavity, which delivers the conditioned air to a vent 96 generating the air curtain C. Airflow from the left and right side first air vents 32 meet at a point 115 in front of the occupant, as shown in FIG. 9. The housing 94 is generally cylindrical in shape and includes first and second windows 98, 100 and an open bottom 102, as best shown in FIG. 8A. The vent 96 is arranged in the first window 98 and includes pivots 104 about which the vent 96 rotates relative to the housing 94. Actuators 117, 118 responsive to an input device 120 may be used by the occupant to adjust the position of an exit 106 of the vent 96 relative to the occupant's position in the seat 20 so as to not blow air directly on the occupant's head or neck. In this manner, the vent 96 may be easily positioned to accommodate occupants of different heights and sizes and with different preferences.

The vent 96 has louvers 108, 110 that provide first and second flow paths 114, 116 separated by a dead zone 112 in which air is not expelled from the exit 106 of the vent 96. The louvers 110 create a baffle that blocks at least 15% of the exit 106, which has a height at least three times its width. It should be understood that no baffle may be used, or baffles that block a lesser or greater amount of the exit 106, for example, 5%-25%. The dead zone 112 is designed to align with the occupant's ear (FIG. 9), which typically is sensitive to direct airflow such that blowing conditioned air on the ear would be unpleasant. In various examples, the dead zone 112 may align with other sensitive anatomy, such as the back of the neck.

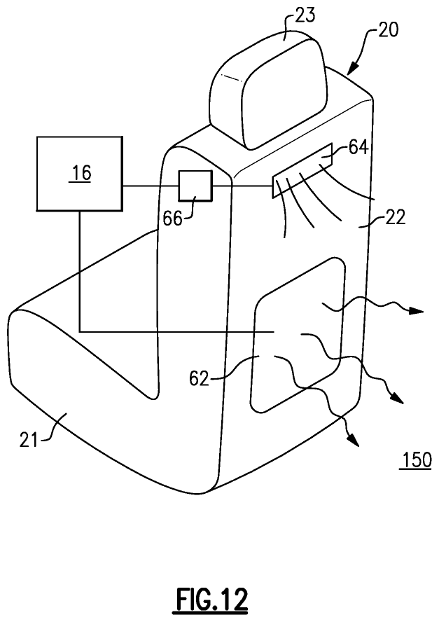

The occupant air curtain system and its boundary layer about the occupant is schematically illustrated in FIGS. 10-11B. The disclosed air curtain system 30 can be used in hot and/or cold vehicle interior environments. The boundary layer provided by the occupant air curtain system 30 is illustrated in “green” (undesired environment is shown in “red”) and creates an envelope that insulates the occupant from the hot interior environment. This better enables the seat bottom and seat back heating and cooling devices to better maintain a comfortable occupant microclimate while the HVAC system brings the interior vehicle environment to a more comfortable thermal equilibrium.

Referring to FIG. 12, a microclimate device/system is provided at the rear of the seat 20 for the rear occupant area 150. The system provides a radiant heater 62 on a lower vertical surface of the seat back opposite the occupant support surface of the front seat 20, for example, integrated with a map pocket. A convective heater/cooler with a vent 64 is arranged above the radiant heater 62 and is configured to direct conditioned air to lower extremities of a rear seat occupant, specifically one or more of the top of the legs, front of the legs, and feet of the rearward seat occupant. The vent 64 is arranged on a horizontal surface of the seat back facing the occupant, but can be located on vertical or side surfaces facing the occupant. A thermoelectric module 66 or the HVAC may supply the conditioned air to the vent.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A vehicle occupant air curtain system comprising:
a seat having a seat cushion and a seat back, the seat back having a region configured to be arranged above an occupant shoulder;
multiple first air vents supported on the seat back and arranged in the region, wherein the multiple first air vent is configured to that respective air flows from the multiple first air vents be directed away from the seated occupant's head and neck and merge in front of the seated occupant,
wherein the seat cushion includes lateral sides that each include a second air vent configured to direct another airflow adjacent to a seated occupant's legs and meet above the occupant's legs so as to continue away from the occupant.

2. The system of claim 1, wherein the seat back includes a head rest, the head rest is adjustable with respect to a seat back support, and wherein the first air vent is located in the seat back.

3. The system of claim 1, wherein the first air vent includes a housing and a vent, the vent movable relative to the housing to position an airflow from the vent adjacent to and away from the seated occupant's head and neck.

4. The system of claim 1, wherein a dead zone in air directed by the first air vent is aligned with the seated occupant's ears.

5. The system of claim 1, wherein the first air vent is configured to provide an airflow having at least two of 99.12[1/min]+/−10%, a Reynolds number of 4500+/−10%, and a velocity of 8 m/s+/−10%.

6. The system of claim 1, wherein the second air vent is configured to provide an airflow having at least two of 99.12[l/min]+/−10%, a Reynolds number of 4000+/−10%, and a velocity of 7 m/s+/−10%.

7. The system of claim 1, wherein the seat is connected to a thermoelectric module configured to provide conditioned air to at least one of the first and second air vents,
and wherein the thermoelectric module draws air from a source substantially other than the first and second air vents.

8. The system of claim 1, wherein at least a portion of airflows from the multiple first air vents merge with each other.

9. The system of claim 1, wherein at least one of the multiple first air vents are located in the upper portion of the seat back.

10. The system of claim 1, wherein at least one of the multiple first air vents is rotatable relative to the seat back.

11. The system of claim 1, wherein at least one of the multiple first air vents provides a first and second channel of airflow, and that a dead zone is formed between the first and second channels.
